(19) United States
(12) Patent Application Publication
(10) Pub. No.: US 2003/0029669 A1
(43) Pub. Date: Feb. 13, 2003

(54) Perforated open volume acoustic resonator

(75) Inventors: Marc Charbonneaux, Lyon (FR); Patrice Morchain, L'lsle D'Abeau (FR); Pierre Piccaluga, L'Isle D'Abeau (FR); Claude-Annie Perrichon, L'Isle D'Abeau (FR)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Pica-Sound International

(21) Appl. No.: 10/222,789

(22) Filed: Aug. 19, 2002

Related U.S. Application Data
(62) Division of application No. 09/856,148, filed on Sep. 4, 2001, now abandoned.

(30) Foreign Application Priority Data
Nov. 30, 1998 (FR) 98/15243

(51) Int. Cl. G10K 11/00

(52) U.S. Cl. 181/175; 181/207

(57) ABSTRACT

The creation of sounds by musical instruments or sound reproduction systems is not perfect, but acoustic dissonances inherent in the production of sound generators can be corrected.

The present method uses open volumes, such as a glass, possibly provided with a cutoff, a fragmentation creating at least one opening. This object placed close to or on a sound generator frees additional sound waves to harmonise with the sound generator by means of mechanical coupling or an air sound link due to the volume of the resonator and its fragmentation.

A device made of a material with a Shore hardness of more than 60 makes it possible via its foot fixed to a piano to transmit mechanical sound vibrations.

Method and device constitute an effective improvement in the reproduction and creation of sounds.

The creation of sounds by musical instruments or sound reproduction systems is not perfect, but acoustic dissonances or sound deficiencies inherent in the creation of sound generators can be corrected to provide a full and total sound.

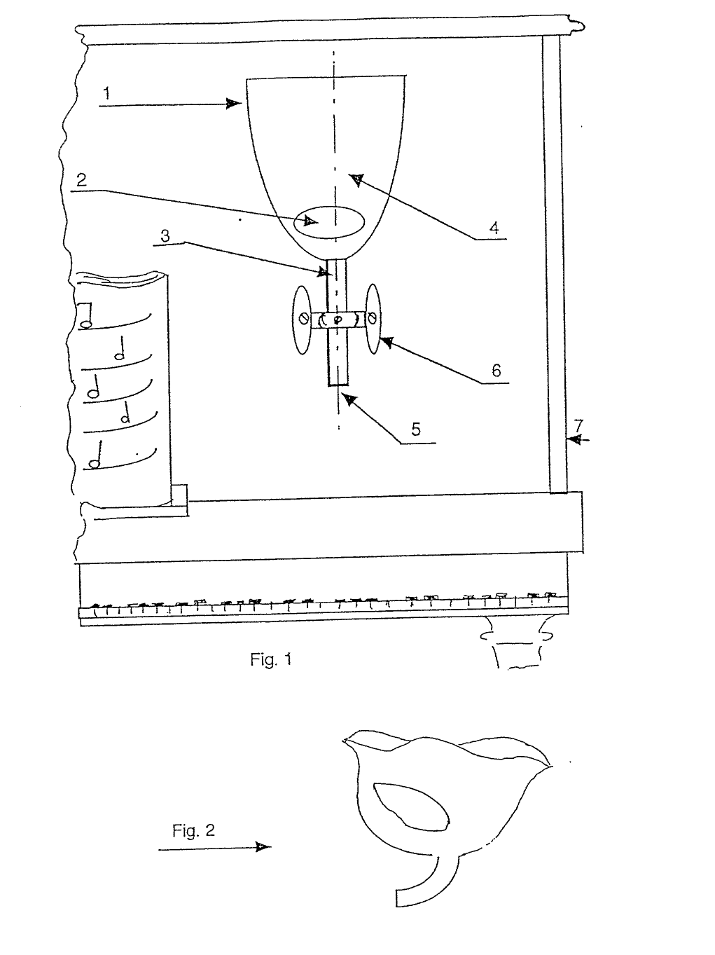

The present method uses the sound characteristics of an open volume, such as an earthenware vase or a glass possibly provided with at least a cut, creating an opening which can be moved out of centre with respect to the main axis of the object. This object, placed close to or on a sound generator, releases additional sound waves harmonising with the sound generator via mechanical coupling or via the resonance of air waves due to the volume and fragmentation of the resonator fixed at a defined location. The overall sound quality is richer and more precise. By means of the resonance of the volume, a large vase with the opening at its base is able to modify the acoustics of a room. The present method includes a fixed acoustic resonator which improves the sounds created by a sound generator or balances the tonal aspect of a room. The present method is embodied by a quartz device in the form of a glass (1) which is cut (2) close to its base like a watch (FIG. 1). In this non-restrictive embodiment example of the method, the addition of a hollow foot (3) enables air to circulate inside the volume (4) at the end of the foot (5). These sound vibration circulations of air by the resonator are useful, independent of one another, and are thus additional to the sound qualities of the instrument. This foot is able to fix this resonator in a brass support (6) which, secured to a piano (7), transmits the mechanical sound vibrations. The acoustics of the resonators is excellent with rigid materials, such as crystal, glass and metals or alloys like bronze. Ceramic materials are also good. The materials whose hardness is greater than Shore hardness 60 are able to embody the device. The shapes can be homogeneous (FIG. 2), but not symmetrical. The method and device constitute an effective improvement concerning the reproduction or creation of sounds.

1. Method characterised by an acoustic resonator with an open volume which, by being close to or placed on a sound generator, frees additional sound waves harmonising with the sound generator.

2. Method according to claim 1, characterised in that it is provided with a cut or fragmentation creating at least one opening.

3. Device constituted by an open homogeneous volume made of a material having a hardness of more than a Shore hardness 60, is an acoustic resonator which, placed on a sound generator via mechanical coupling, frees additional sound waves harmonising with the sound generator.

4. Device according to claim 3, characterised by at least one cut or fragmentation creating an opening.

5. Device according to claim 3 or 4, characterised by the overhead sound resonance linked to the volume of the resonator.

6. Device according to claim 3 or 4, characterised in that the resonator is mounted on an additional foot.

7. Device according to one of claims 3 to 6, characterised in that the shape is not symmetrical.

8. Device according to one of claims 3 to 7 and made of quartz or crystal, glass or a ceramic material.

9. Device according to one of claims 3 to 7, characterised by the usage of metals or metal alloys.
